(19) United States
(12) Patent Application Publication
(10) Pub. No.: US 2006/0259331 A1
(43) Pub. Date: Nov. 16, 2006

(54) Medical records website and related methods

(76) Inventors: Agi Clara Lurtz, Edmond, OK (US); Bradley S. Williams, Plano, TX (US)

Correspondence Address: Mr. Martin A. Weeks, 1909 Aladdin, Norman, OK, 73072, US

(21) Appl. No.: 11/434,293

(22) Filed: May 15, 2006

Related U.S. Application Data
(60) Provisional application No. 60/681,028, filed on May 16, 2005.

(51) Int. Cl. G06F 19/00; G06F 17/30

(52) U.S. Cl. 705/3; 707/9

(57) ABSTRACT

The invention is for a medical records website and for methods for collecting, storing, and distributing medical information over the internet. The website contains web pages containing electronic medical forms that a patient may access from any computer. A patient sees initially empty data fields on the electronic medical forms and the patient is prompted to complete information in the data fields. After a patient has input the medical information into the electronic medical form, the website prompts the patient to submit the electronic medical form to a patient database. The patient is queried whether to integrate the patient database with a healthcare provider database. The website also has electronic medical forms for the healthcare providers to input medical observations of the patients. The healthcare providers may also access the website and the healthcare provider database from any computer connected to the internet.

### CROSS-REFERENCE TO RELATED APPLICATIONS

This application relates to U.S. Provisional Patent Application 60/681,028 filed May 16, 2005.

### BACKGROUND OF THE INVENTION

1. Field of the Invention

The invention relates generally to medical records and more specifically to methods for collecting, storing and distributing medical information over the internet.

2. Description of the Related Art

Whenever a patient walks into a physician's office for treatment, she is typically given an array of medical forms to complete. Unfortunately, not everyone carries with them all the information one needs to complete the forms. Some of the questions on the medical forms require time to recall all the symptoms one experienced during an illness. If there is a lapse of time between an illness and a visit to a healthcare provider, the patient may inaccurately remember the details of the illness. Thus, it is desirable for patients to have ready access to the proper forms soon after an illness.

There have been many advances over the past decade in technology in making computer applications available using a World Wide Web. The World Wide Web, or internet, has several advantages over intranet or closed-loop systems. The primary advantage is that the internet can be accessed through millions of home computers that are connected to the internet system. This is particularly advantageous for patients who may be suffering from an illness and for whom it is an inconvenience to travel to the healthcare provider just for filling out medical forms. One possible disadvantage of internet communication between a patient and a healthcare provider is that a patient's privacy may be compromised by inadequate security measures.

Thus, it is desirable to have a secure computer and database system that a patient may access at any time from home via a worldwide web. Such a system would increase the reliability, privacy and accuracy of the data provided to the system by the patient.

### BRIEF SUMMARY OF THE INVENTION

The invention is for a medical records website and a method for creating a secure patient database that a patient, care giver, or parent (hereinafter patient) may access from home via a World Wide Web or internet. Healthcare providers may also create and access a healthcare provider database using the internet. The method is implemented by a web-based computer program code that creates a medical records website that is stored on a web-based server. The users of the website may include patients, healthcare providers, pharmacists, health insurance companies or related organizations. The medical records website provides a graphical user interface (GUI) to facilitate the use of the computer program from a home or office computer by patients who generally have little knowledge of computer programming.

A web designer creates the web-based computer program by first contacting several healthcare providers. The healthcare providers submit to the web designer copies of typical medical forms and questionnaires that the healthcare provider uses in the healthcare provider's service. Based on the healthcare provider forms and questionnaires, the web designer creates web pages for each healthcare provider on the medical records website. On these web pages, the computer program displays electronic medical forms that may be completed by the patient. After completing the initially blank electronic medical forms, the patient clicks on a SUBMIT button to create a patient database or to add information to an existing patient database.

The computer program then prompts the patient to authorize the integration of the patient database with a healthcare provider database. After the information has been added to the healthcare provider database, the healthcare provider can then access the information on web pages presented for the healthcare provider's review. The healthcare provider may also add to both the healthcare provider and patient databases by completing electronic forms to record information when a patient visits the healthcare provider. In an alternative embodiment, the patient does not integrate the patient database with the healthcare provider database, but makes the patient database available for viewing by authorized healthcare providers.

### BRIEF DESCRIPTION OF THE DRAWINGS

FIG. 1 shows a front elevation view of a computer system.

FIG. 2 shows a schematic diagram illustrating the flow of information from the patient to a physician.

FIG. 3 shows a schematic diagram illustrating the flow of information from the patient to a hospital and organizations affiliated with the hospital.

FIG. 4 shows a schematic view of a web page that is a home page for the medical records website.

FIG. 5 shows a web page that is the patient page after logging onto a secure portion of the medical records website.

FIG. 6 shows a web page that contains the first page of a healthcare provider's electronic medical form.

FIG. 7 shows a web page that contains the second page of a healthcare provider's electronic medical form.

FIG. 8 shows a web page that contains the third page of a healthcare provider's electronic medical form.

FIG. 9 shows a web page containing a listing of healthcare providers that have submitted medical forms to the medical records website.

FIG. 10 shows a web page that is the healthcare provider page after logging onto the secure portion of the medical records website.

FIG. 11 shows a web page that a healthcare provider uses to search for patients in the healthcare provider database.

FIG. 12 shows a web page with a record of visit form that a healthcare provider uses when a patient visits the healthcare provider.

FIGS. 13A-13D show a flow chart for a method for collecting, storing and displaying medical information using a medical records website.

FIG. 14 shows a web page that is the patient page of the medical records website.

### DESCRIPTION

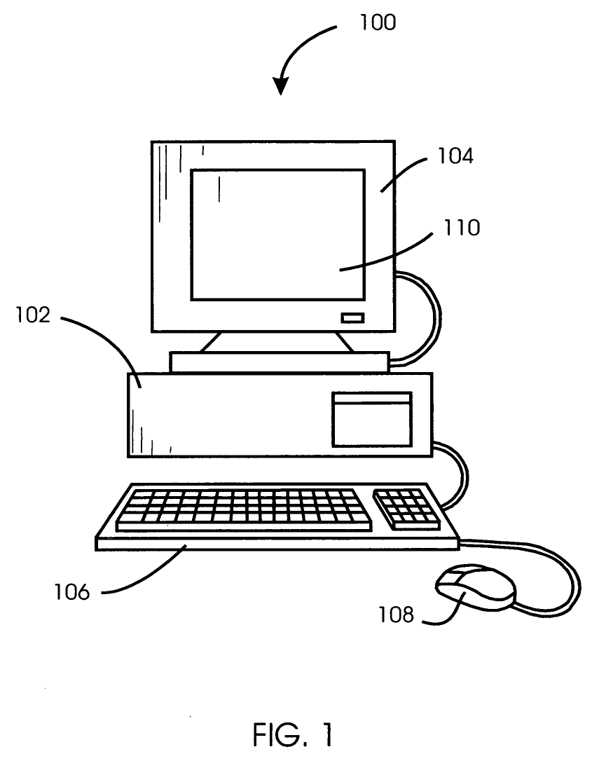

FIG. 1 shows a typical computer 100 that is used for accessing a website over the internet. The computer 100 includes a microprocessor housed in a case 102, a monitor 104, a keyboard 106 and a mouse 108. A computer user views information shown on the display 110 via a graphical user interface (GUI). The microprocessor runs software programs that are viewed on the display 110. The user inputs information into the software program using the keyboard 106 and the mouse 108. The mouse 108 controls the position of a cursor on the GUI.

One of the software programs typically loaded into the computer 100 is an internet browser which enables the user to view information and programs on the internet or World Wide Web. The computer 100 may be connected to the internet by either a cable or a wireless connection. The wireless connection to the internet permits users to access the internet from locations away from their home, office or place of business. On a typical website, one uses the mouse 108 to move the cursor to a designated position in a web page and clicks on the mouse to cause an action to occur on the GUI.

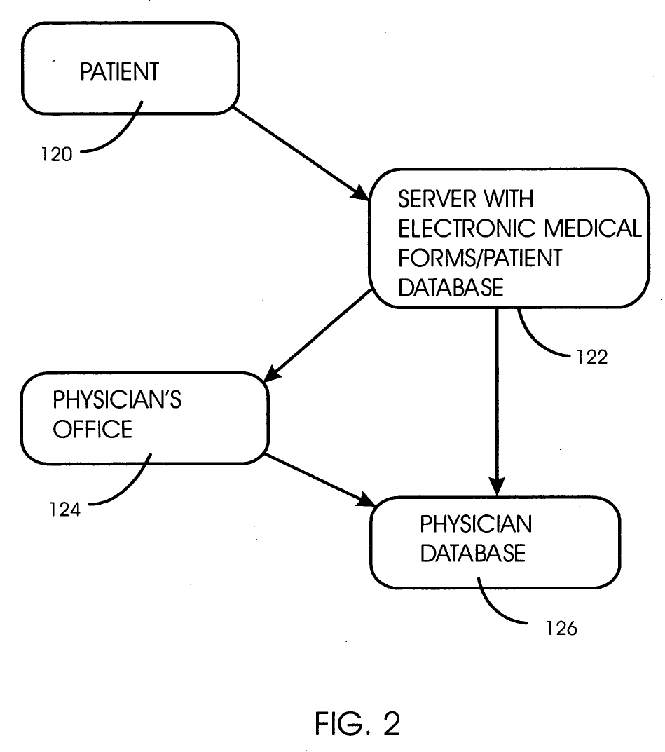

In accordance with the present invention, FIG. 2 shows a schematic diagram of the information that flows from a patient 120 to a physician's office 124 and a physician's database 126. The patient 120 logs onto a secured portion of a medical records website stored on a server 122. The server 122 contains the medical record website with electronic medical forms prepared by a web designer and programmer (web designer). The server 122 also contains a patient database with data from the completed electronic medical forms. In one embodiment of the present invention, after the patient authorizes the physician to receive the information in the patient database, the physician can read the information in the physician database 126 by accessing the medical records website from the physician's office 124 and the information in the patient database is also integrated into the physician database 126. In another embodiment of the invention, the physician may view a portion or all of the patient database after the patient grants the physician authorization to so view the patient database, but the patient database is not integrated with the physician database 126.

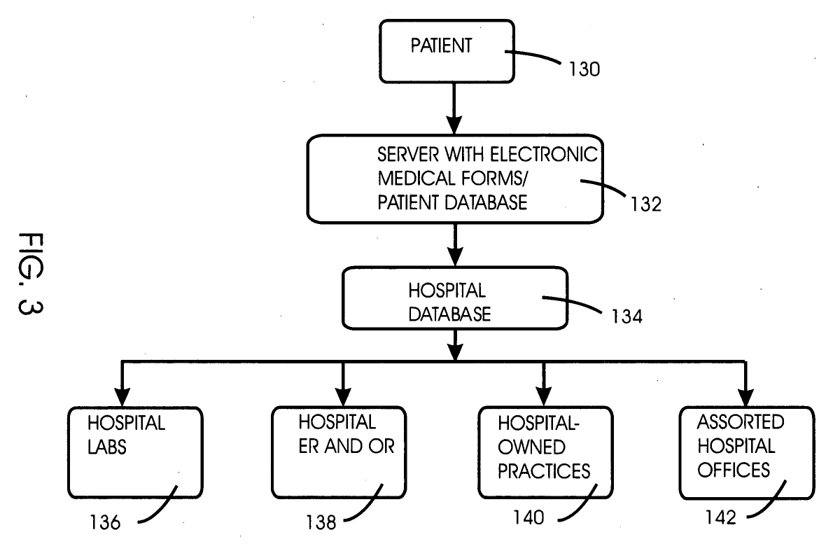

FIG. 3 shows a schematic diagram of the information that flows from the patient 130 to a hospital database 134 and several organizations affiliated with a hospital. As in FIG. 2, the patient logs onto a secure portion of the medical records website located on a server 132 having the electronic medical forms and a patient database. After the patient authorizes the hospital to receive the information in the patient database, the server 132 can then integrate the patient database with the hospital database 134. Once the patient database is integrated with the hospital database 134, the information can then be accessed by the hospital laboratories 136, the hospital operating room and emergency room 138, hospital-owned practices 140 or assorted hospital offices 142.

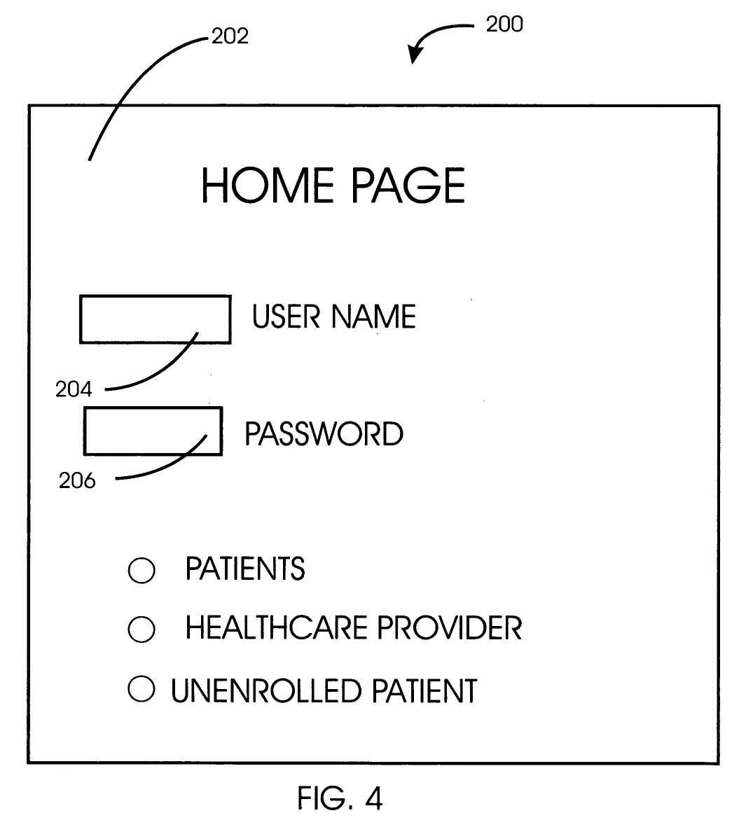

FIG. 4 shows a HOME PAGE 202 of the medical record website 200. A user, either a patient or healthcare provider, enters the website by typing in the uniform resource locator (URL) on the address line of an internet browser program. When the user has entered the URL, the HOME PAGE appears. The HOME PAGE 202 has a USER NAME data field 204 and a PASSWORD data field 206, in which the user may type in a user name and a password to gain access to the secured portion of the medical records website 200. The computer program that created the medical record website 200 can distinguish between patients and healthcare providers based on the user name. If the user has already obtained a user name and password on a previous visit to the medical records website, the user may log onto the secured portion of the medical records website 200.

As shown in FIG. 4, the HOME PAGE 202 may also have links to click to indicate whether the user is a new patient, a new healthcare provider, or a new unenrolled patient. When the user clicks on one of these links, a web page appears that asks the user their e-mail address and security questions before entering the secured portion of the medical records website 200. The security questions may be related to their social security number, their mother's maiden name, their favorite pet or any other information that is personal to the user. The medical records website 200 then sends an e-mail to the user containing the user's user name and password. The password may be changed on a frequent basis to prevent security breaches. With the user name and password, the user can gain access to the secure portion of the website.

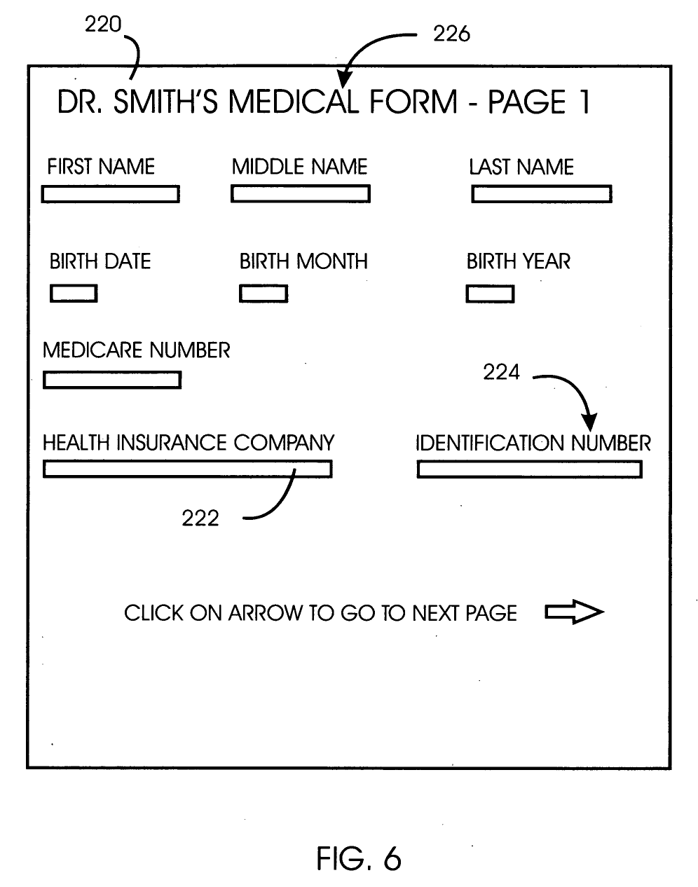

For patients who are not yet enrolled in the medical records website service, the patient may click on the link for unenrolled patients. The unenrolled patients can use the medical records website to create their own patient database using generic electronic medical forms similar to the forms described in FIGS. 6-8 below for enrolled patients. These patients will then have an incentive to use one of the healthcare providers who subscribe to the medical records website 200.

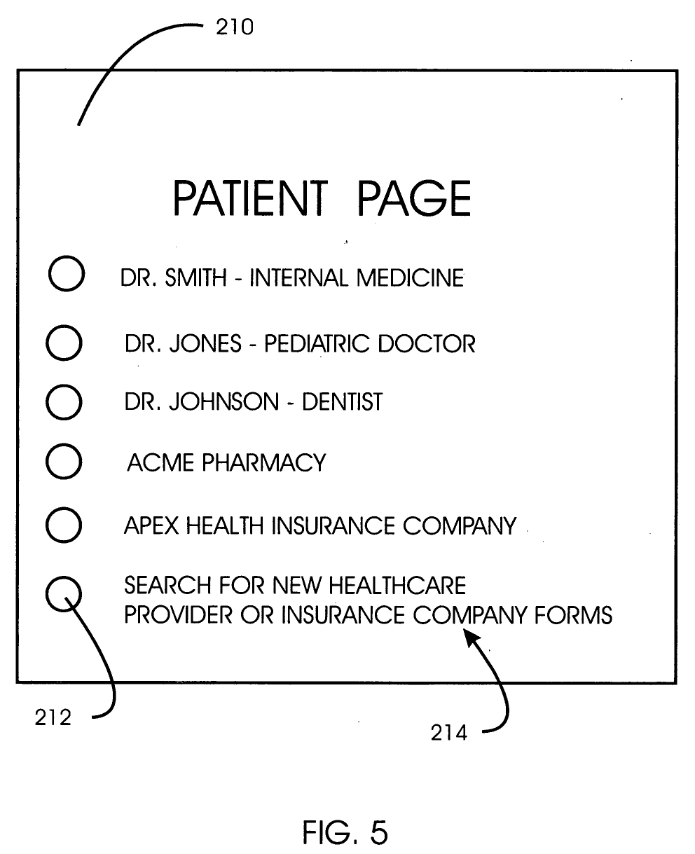

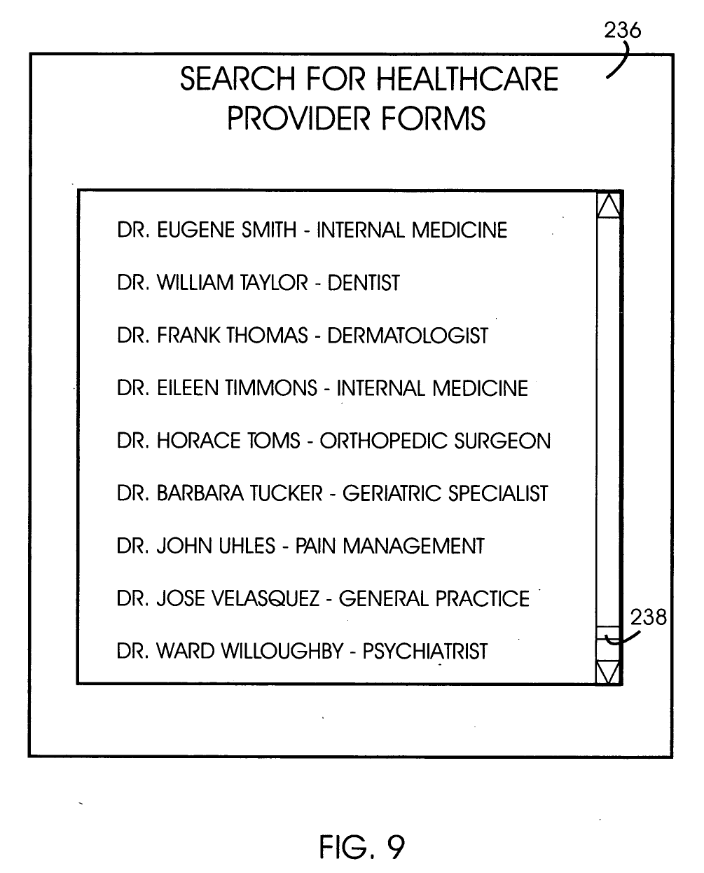

After the user logs onto the secured portion of the medical records website 200, the next web page that appears is an administrative area, for either a patient or a healthcare provider. FIG. 5 shows a web page of the medical record website200 entitled PATIENT WEB PAGE 210. The actual title of the web page is not important as long as it performs the function of an administrative area for the patient. The PATIENT WEB PAGE 210 has a plurality of INTERNAL LINKS 212 that, when clicked with the mouse108 shown in FIG. 1, take the patient to a web page corresponding to the LINK LABELS 214 that appear next to the INTERNAL LINKS 212. The LINK LABELS 214 shown in FIG. 5 generally correspond to different healthcare providers and health insurance companies. However, when the patient wishes to add a new healthcare provider or health insurance company, the patient may go to a SEARCH PAGE (shown in FIG. 9) where the patient may search for physicians and health insurance companies that have forms on the medical records website 200.

Thus, the healthcare providers and health insurance companies derive a benefit from putting their forms on the medical records website, because a patient will be more willing to seek out doctors who subscribe to the medical records website 200. Once a patient has filled out an electronic medical form for a healthcare provider, the name of the healthcare provider is automatically added to the PATIENT PAGE 210.

FIG. 6 shows a web page 220 containing an electronic medical form for one of the healthcare providers, namely DR. SMITH. The web page 220 has several empty data fields 222 with field names 224. A label 226 at the top of the page indicates that the web page indicates that the patient is at DR. SMITH'S MEDICAL FORM—PAGE 1. A patient types in the information corresponding to the field names 224 for the empty data fields 222. For the particular page 220 shown in FIG. 6, the information on the electronic medical form is the identifying information. An arrow at the bottom of the page is a label for an internal link to the second page of Dr. Smith's electronic medical form.

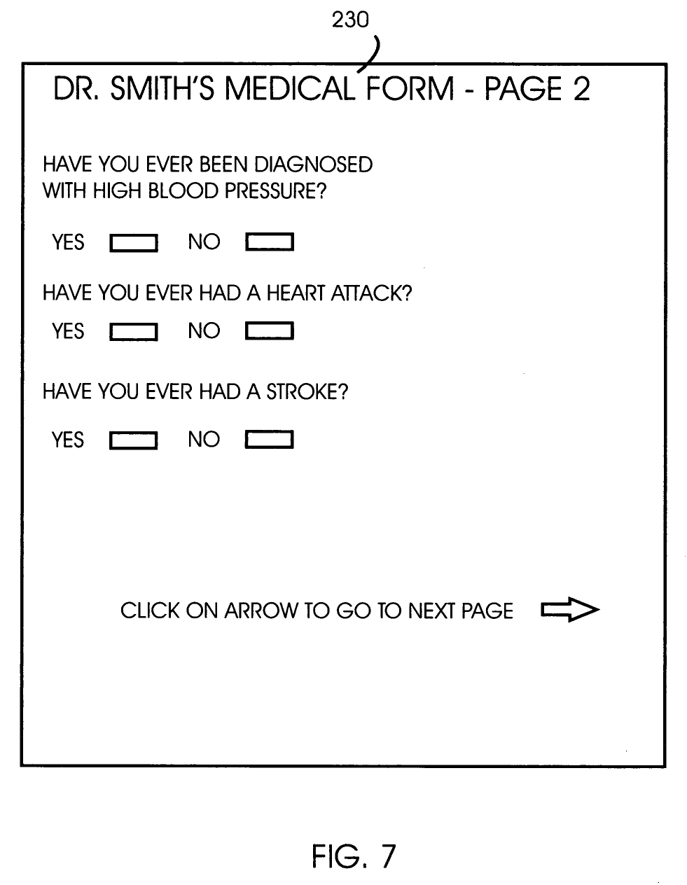

FIG. 7 shows a web page 230 that is a second page of Dr. Smith's medical form. For the web page230 shown in FIG. 7, the information sought on the web page 230 is basic medical information regarding the patient.

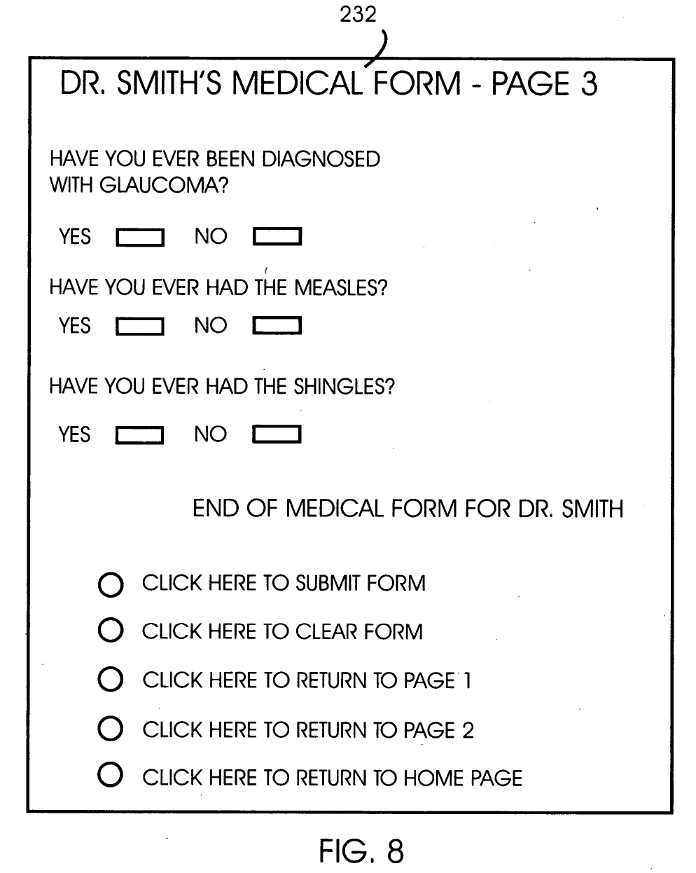

FIG. 8 shows a third page of Dr. Smith's electronic medical form. For this simple example, the third page of the electronic medical form is the last page. At the bottom of the web page 232 is a SUBMIT button 234. When a user clicks on the SUBMIT button 234, the information typed in the data fields by the patient is stored in a patient database on the server that contains the website. There are also links at the bottom for the patient to clear the electronic medical form and to return to previous pages accessed in the website.

The web designer who designs the electronic medical forms for several healthcare providers may integrate the various forms to minimize the repetition of the questions on the medical record forms. Thus, the patient or healthcare provider does not have to answer the same questions multiple times because, when a new form is added to the website, the information from a form filled out for a previous healthcare provider may be used to populate the data fields of the new healthcare provider form.

FIG. 9 shows a SEARCH PAGE 236 that a patient uses for searching for the electronic medical forms for healthcare providers that subscribe to the website. A scrolling tab 238 assists the patient in locating the desired healthcare provider more quickly. After a patient clicks on one of the healthcare providers listed on this page, the patient is taken to a web page like the web page shown in FIG. 6, which contains the electronic medical forms for the selected healthcare provider. Once a patient has added a healthcare provider to the patient database by filling out and submitting the healthcare provider's forms, the name of the healthcare provider automatically appears on the PATIENT PAGE when the patient again logs onto the secured portion of the medical records website 200.

It is expected that the medical records website 200 may be a subscription service for advertising the services of healthcare providers. Those healthcare providers who subscribe to the medical records website are then listed on the SEARCH PAGE of the medical records website.

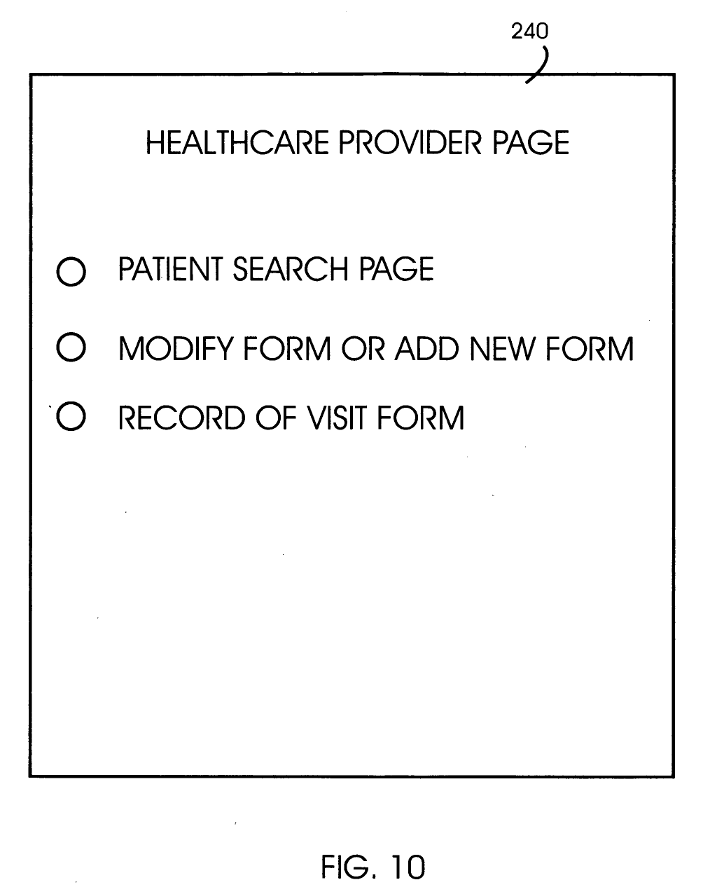

FIG. 10 shows a web page 240 entitled the HEALTHCARE PROVIDER PAGE. This web page 240 is the first page a healthcare provider sees after logging onto the secured portion of the medical records website 200. The web page 240 has three internal links to other web pages within the medical records website 200. The first link is to a PATIENT SEARCH PAGE where the healthcare provider can search by patient name and access the electronic medical forms that the patient has completed for the healthcare provider who has logged onto the medical records website 200. The PATIENT SEARCH PAGE has the same general appearance as the SEARCH PAGE shown in FIG. 9, but generally includes the names of patients of the healthcare provider accessing the website instead of the names of healthcare providers.

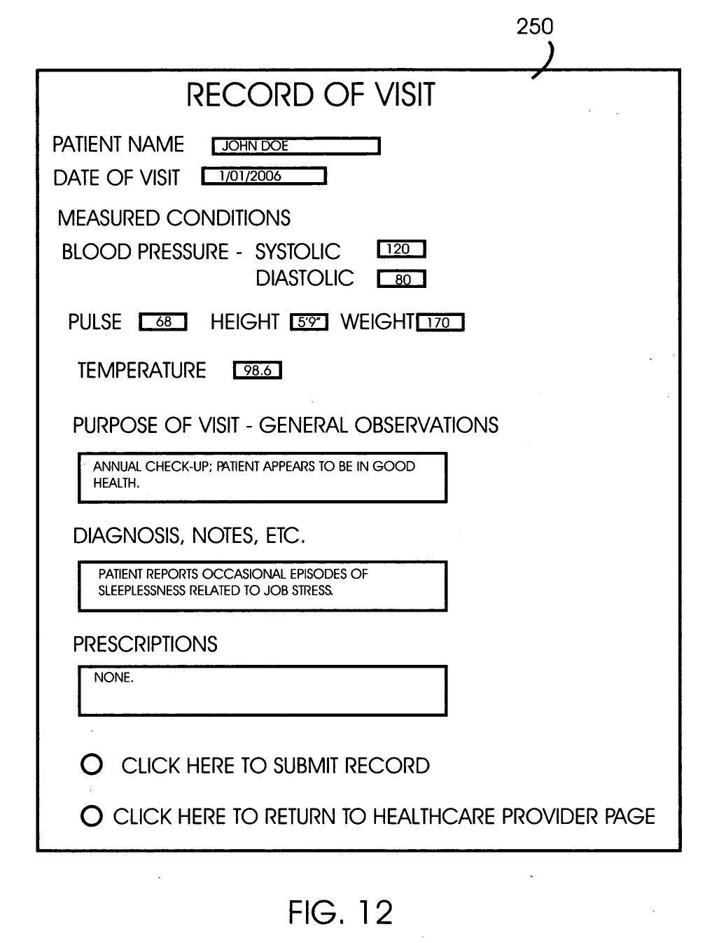

The second link is to a web page which contains the initially blank electronic medical forms that the healthcare provider has placed in the medical records website for the patients to fill out. At this web page, the healthcare provider may modify an existing blank electronic medical form or add a new blank electronic medical form. A third link on the HEALTHCARE PROVIDER HOME PAGE is to a RECORD OF VISIT FORM, which is explained in more detail with regard to FIG. 12.

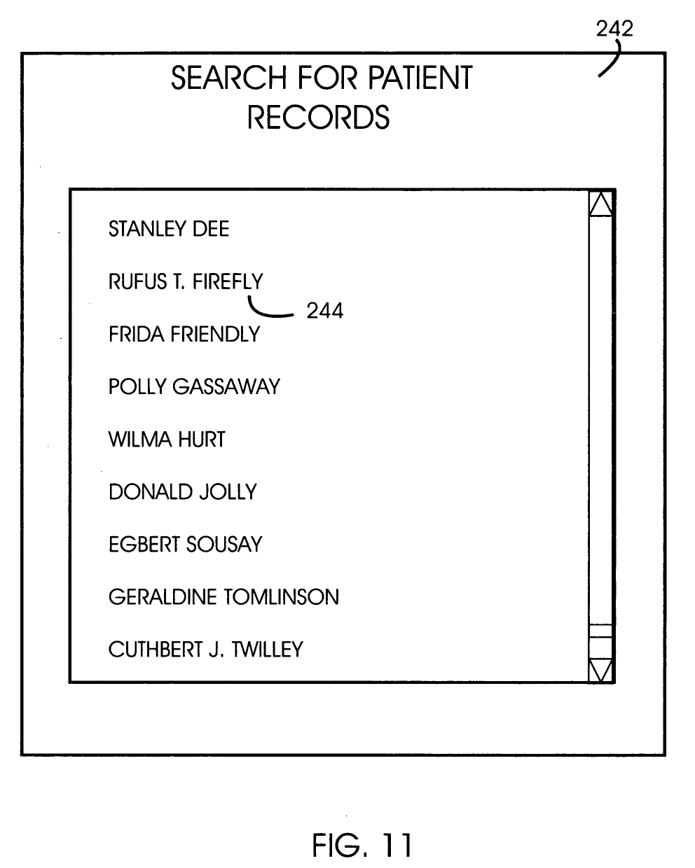

FIG. 11 shows a SEARCH FOR PATIENT RECORDS web page 242 that a healthcare provider may use to search for patient records. The web page 242 displays a list of patient names 244 that the healthcare provider may select for displaying that patient's records. When the healthcare provider selects one of the patients, a web page appears with the patients' most recently completed electronic medical form.

FIG. 12 shows a RECORD OF VISIT form that a healthcare provider may use to record the healthcare provider's observations of the patient during a visit. In FIG. 12, the healthcare provider has completed the RECORD OF VISIT form.

There is a button at the bottom of this web page 250 to submit the record, which when clicked, adds the RECORD OF VISIT form to the healthcare provider database and to the patient database for the patient visiting the healthcare provider. Another button at the bottom of the RECORD OF VISIT form is a link to return the healthcare provider to the HEALTHCARE PROVIDER PAGE.

For all of the electronic medical forms shown in the drawings, the electronic medical forms shown are not the actual forms used in the actual medical records website 200. Rather, the electronic medical forms shown are meant to be representative of the types of forms that may exist on the medical records website 200.

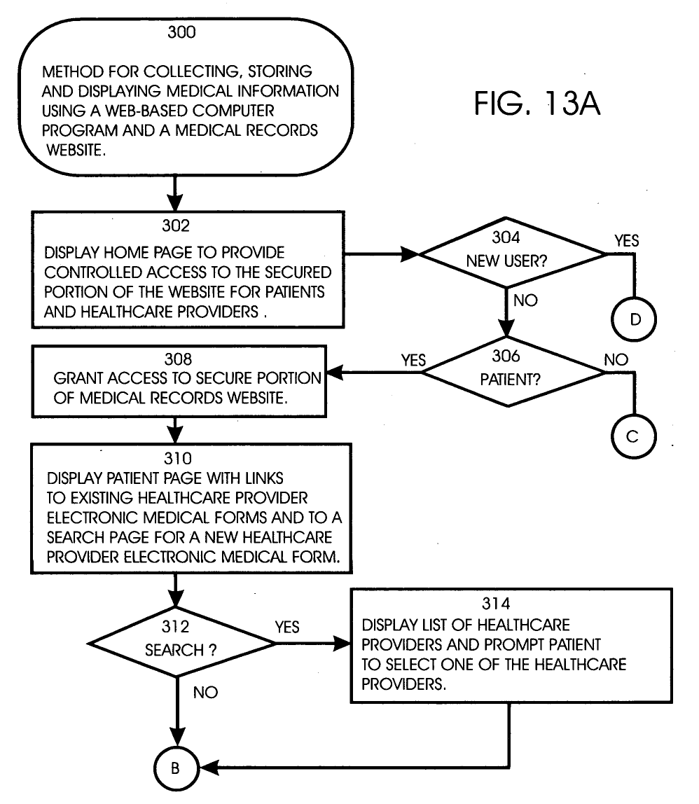

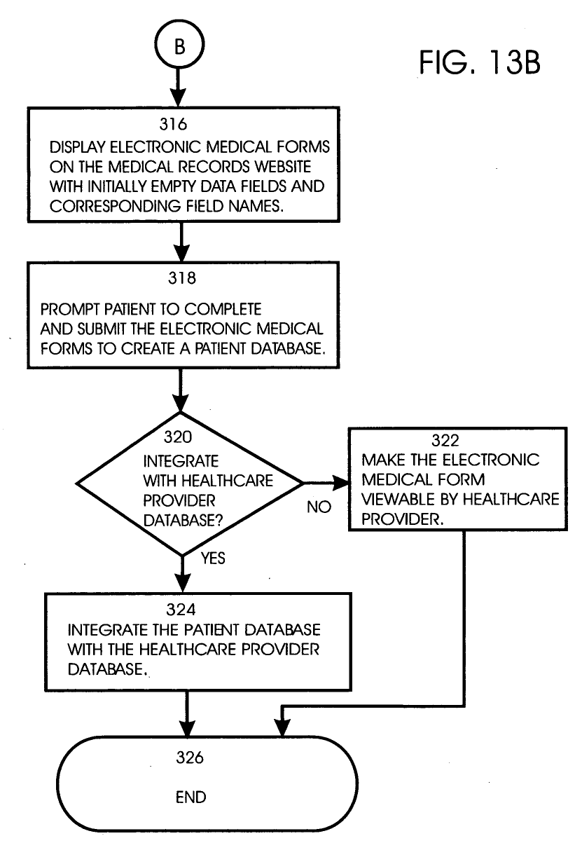

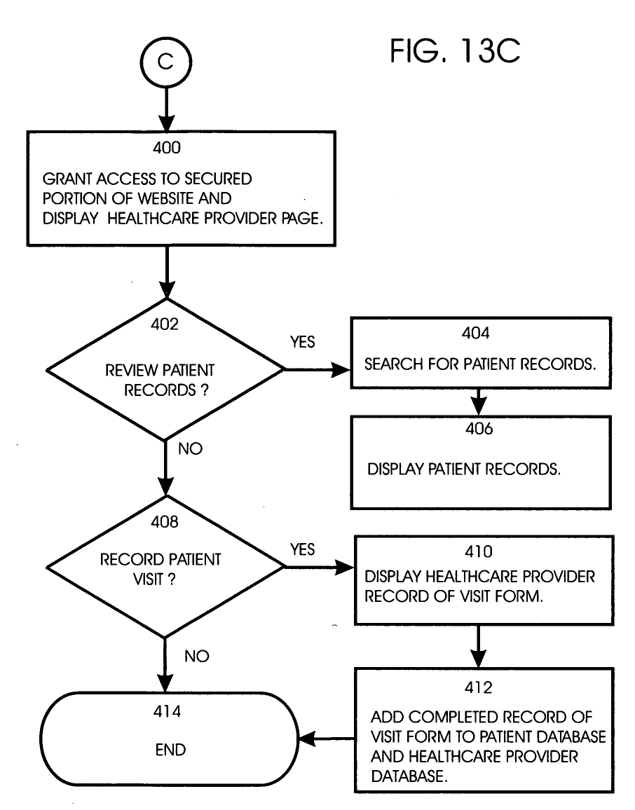

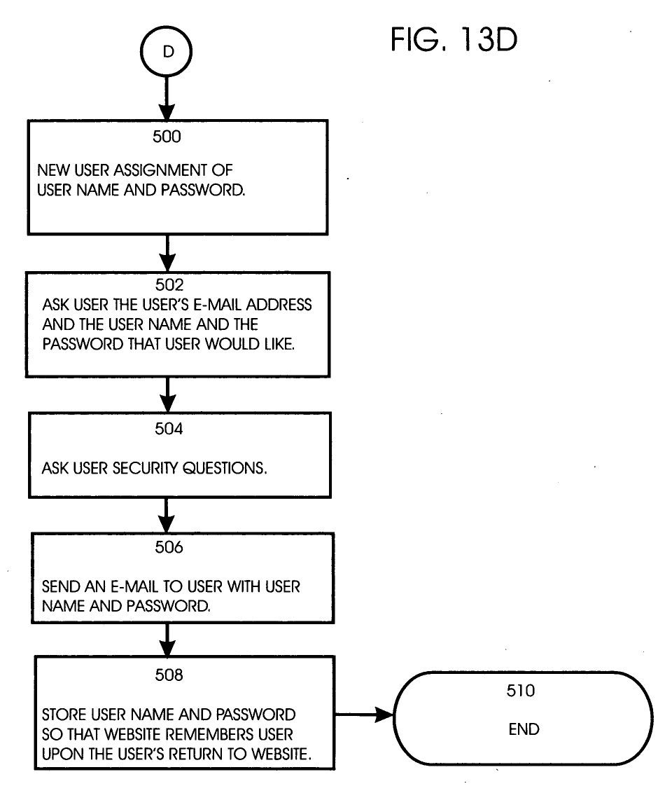

FIGS. 13A-13D show a flow chart for a method 300 of collecting, storing, and displaying medical information for a patient using a web-based computer program and a medical records website generated by the computer program. The first step 302 of the method 300 is that, when a user types in the URL, the medical records website displays a HOME PAGE with USER NAME and PASSWORD boxes to provide controlled access to the secured portion of the medical records website for patients and healthcare providers.

At step 304, the HOME PAGE also has links by which new users, new healthcare providers, and unenrolled patients may be assigned a user name and password. If the user is a new user, the method goes to a web page at step 500 to assign the user a user name and password, as shown in FIG. 13D.

The next step 306 is that the program determines whether a user of the medical records website is a patient or a healthcare provider. This may be accomplished by providing a table of unique user names and associating the user names with patients and healthcare providers. This also may be accomplished by having an indicator box for the patient to select when the user logs onto the website.

At step 308, if the user is a patient, the website grants access to the patient who has logged onto the secured portion of the website. If the user is a healthcare provider, the website displays a HEALTHCARE PROVIDER PAGE at step 400, which is shown in FIG. 13C. At step 310, the website displays a PATIENT PAGE. At the PATIENT PAGE, the website displays several options from which the patient chooses one of the options.

The patient may choose to search for a new healthcare provider's electronic medical forms at step 312. If the patient chooses to search for a form for a new healthcare provider, the website displays at step 314 a list of healthcare providers who have submitted medical forms to the medical records website.

At step 316, if the patient chooses one of the healthcare providers listed at step 310, one of the electronic medical forms for that healthcare provider is displayed. Whether the patient chooses a healthcare provider for which that patient has previously filled out an electronic medical form or whether the patient has selected a new healthcare provider, the website displays at step 316 an electronic medical form for the selected healthcare provider. The electronic medical form has initially empty data fields associated with corresponding field names. At step 318, the patient is prompted to complete the electronic medical forms and submit the electronic medical forms.

At step 320, the website displays a question asking the patient whether the patient is sure that he wants to integrate the information in the electronic medical form with the database of the selected healthcare provider. If the patient answers “no” to the question at step 320, the website makes the electronic medical form merely viewable by the healthcare provider who submitted the form. At step 324, wherein the patient has answered “yes to the question at step 320, the website then integrates the information in the medical forms with the healthcare provider's database. The patient portion of the method for collecting, storing and displaying medical information over the internet ends at step 326.

For a healthcare provider, after the healthcare provider logs onto the secure portion of the medical records website, the computer program grants access to the healthcare provider and displays a health care provider page at step 400, as shown in FIG. 13C. For the healthcare provider portion of the website, the healthcare provider may either review a patient's records or record observations from a patient visit. At step 402, the website displays a question asking whether the healthcare provider wants to review a patient's records. If the answer to this question is yes, the website displays a search page at step 404 where a healthcare provider may perform a search on the healthcare provider database for a patient's medical records. Once the patient's records are located, the website displays the patient's records at step 406.

If the healthcare provider does not want to search the patient records at step 402, then at step 408 the website queries the healthcare provider whether the healthcare provider wishes to obtain a form for recording observations during a patient visit. If the answer to this query is yes, the website displays at step 410 a RECORD OF VISIT form, which has initially empty data fields and which also has field names associated with the various data fields. During or after the patient visit, the healthcare provider may fill in the empty data fields and then submit the information in the completed form to the healthcare provider database for that patient and to the patient database. The healthcare provider portion of the method for collecting, storing and displaying medical information over the internet ends at step 320.

FIG. 1 3D shows the method 500 by which the website assigns user names and passwords to new users of the medical records website. At step 502, the website asks the user the user's e-mail address and the user name and password the user would like to use. If the user name and password chosen are acceptable, the website then asks the user two security questions at step 504. At step 506, the website then automatically sends an e-mail to the user with the user name and password assigned to the user. At step 508, the website then stores the name of the user name and password on the computer so that the website remembers the user upon the user's return to the website. The method ends at step 510.

The integration of the patient database and the healthcare provider database is generally accomplished by one of two methods. If the healthcare provider uses the same type of database program that is used for the patient database, then the information in the electronic medical form is stored as a patient file that a healthcare provider may open with the healthcare provider database. If the healthcare provider database program is different from the patient database program, then the patient database program must export the information to a file format compatible with the healthcare provider database program before the healthcare provider can view the electronic medical form on the healthcare provider's computer.

All communication between the server and the user's computer (client) occurs over a secure socket layer (SSL). SSL provides endpoint authentication and communications privacy over the internet using cryptography. SSL protocols allow server/client applications to communicate in a way designed to prevent eavesdropping, tampering and message forgery. All information sent to the server from the client is stripped of potentially harmful characters and key sequences to prevent malicious input. Potentially harmful data that is stripped includes data entered directly by the user, such as user names and passwords, and or data that is sent indirectly, such as page numbers or tab identifications.

For the methods described above, the user accomplishes access validation by entering a personal user name (“username”) and password entry. The patient then has access only to records for which the patients are authorized. The healthcare provider is granted access to all patient files for which the healthcare provider is identified as a healthcare provider of record by the patient

The healthcare provider generally has the ability to access the healthcare provider database from any computer connected to the internet at any time of day. This is especially useful when the patient has contacted the patient after normal office hours and it is important for the healthcare provider to have access to the healthcare provider database.

Ambulance services and emergency medical technicians (EMTs) can retrieve the information from the website about a patient in seconds using wireless internet service. For those cases where wireless internet service is not available, the emergency room personnel at a hospital can access the patient information can access the information in an emergency by retrieving the patient information through a standard internet connection.

An emergency care provider may access the patient database using the username and “passkey” entry. The passkey is similar to a password, but the use of the passkey is an indicator to the database that only certain types of information is to be shared. For example, the passkey may limit allow the emergency care provider to see all relevant medical records, but may not allow the emergency care provider see the social security number or financial matters relevant to the patient's payment history. When a passkey is used to access the patient database, an e-mail is sent to the patient's e-mail address to notify the patient that a healthcare provider has accessed the patient database.

None of the information used in an internet session is stored by the internet browser by “cookies” or any other means. After a user logs out from an internet session, all of the information from the session is deleted from the user's computer. Because some of the medical forms may take more than a few minutes to complete, no user is “timed out” or logged off the medical records website due to a period of inactivity.

The frequent need to expand the number of information options of data requires a dynamic set of field names and a dynamic storage method. All information entered into forms for all users, both patients and healthcare providers, is stored in a single table of data. The core data structure and design accommodates new data fields without requiring modification of the data table structure. The core data structure consists of two essential tables: (1) a table for field names, and (2) a table for data associated with the field names. The data table, in turn, has three essential fields: (A) a field for the user ID that identifies who the data belongs to; (B) a field for the field name that the data represents; and (C) a field that holds the data. With this data structure, when a new healthcare provider is added to the system, new fields specific to that healthcare provider may be added as data in a table rather than restructuring the entire table, which would probably require extensive testing before implementation.

Data is encrypted just prior to being saved the patient database. The data is only decrypted upon retrieval from the medical records website by an authorized request. All data entered into the database is time-dated and user ID-stamped, which means that the data is associated with a clock setting on the server and the user ID of the user inputting the information. This stamping allows for data expiration checks and ensures that data may only be modified by the user who input the data.

The patient is the only user who may enter or modify information in the patient forms. Healthcare providers may enter information into healthcare provider forms that are linked to each patient's form to note important conditions or corrections needed. The date and user of every entry is recorded.

Patient data may be arranged into groups that allow for multiple users such as staff members to view the records that are linked to the group. An example of a group may be a doctor's office and all members of his support staff would be members of the group. The patient authorizes that group to view the medical records by submitting the patient forms to the medical records website and integrating the patient database with the healthcare provider database. Each staff member may have an individual user login name that may afford unique privileges to that user. For example, the doctor may restrict everyone but himself and his head nurse from accessing particular types of medical information. Individual login names may be changed or disabled without affecting the rights of the other group members. This may be necessary in the case of a disgruntled ex-employee.

In one embodiment of the invention, the patient database is never integrated with the healthcare provider database. For this embodiment, when a patient enters data into the patient database and submits the form to the medical records website, a data record is added linking that patient to the doctor whose form is being submitted. This record allows the healthcare provider to view the view that patient's completed electronic medical form. Multiple records may be added for each patient to allow multiple healthcare providers to view the patient information.

In yet another embodiment of the invention, the medical records website may query the patient whether the patient wants the patient database to be integrated with the healthcare provider database or whether the patient wants the patient database to be merely viewable by the healthcare provider. For this embodiment, the healthcare provider may have the option of refusing to service patients who do not choose to integrate the patient database and the healthcare provider database.

For the embodiments for which the patient database is merely viewable by the healthcare provider, a patient may disable the access of a healthcare provider to the patient database. Similarly, a healthcare provider may disable access of a patient to the healthcare provider database.

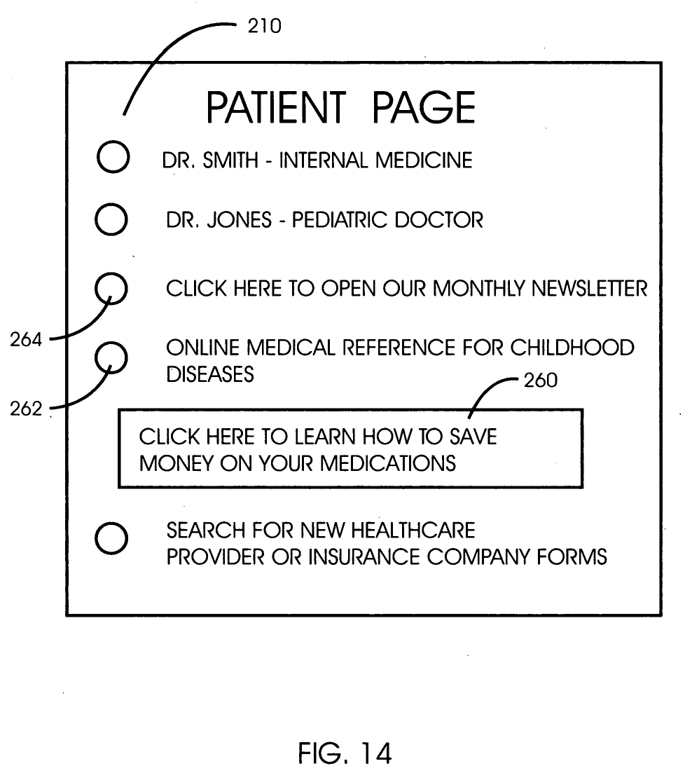

In addition to the functional portions of the medical records website 200, it is also anticipated that an operator of the medical records website 200 can further his profits by selling advertisement space on the website. For example, as shown on the PATIENT PAGE 210 in FIG. 14, the medical records website 200 may display advertisements 260 for physicians and other medical services directed at patients. Similarly, the medical records website 200 may present advertisements for pharmaceutical medicines on the HEALTHCARE PROVIDER PAGE shown in FIG. 10. The medical records website 200 may display links, such as link 262, to other websites with medical information or drug information. The medical records website 200 may also display a link 264 to open a monthly newsletter with medical advice presented in a journalistic format.

The web-based computer program used to create the website may be any standard program used to create a website. These computer programs are typically based on the Java programming language or hypertext mark-up language (HTML), but it is also contemplated that in the future other programming languages may be developed that are appropriate for the medical record website described above.

The term “secure portion of the website” means those web pages for which the user may input data into the electronic medical forms, may view data, or may otherwise exchange information between the server and the user's computer.

It is to be understood that even though numerous characteristics and advantages of various embodiments of the present invention have been set forth in the foregoing description, together with details of the structure and function of various embodiments of the invention, this detailed description is illustrative only, and changes may be made in detail, especially in matters of structure and arrangements of parts, within the principles of the present invention to the full extent indicated by the broad general meaning of the terms in which the appended claims are expressed.

What is claimed is:

1. A computer-implemented method for collecting, storing, and displaying medical information for patients on a medical records website, the method comprising the steps:
(a) granting the patients secure access to a secure portion of the medical records website;
(b) displaying web pages of the website, the web pages containing electronic medical forms having initially empty data fields and a field name associated with each data field, wherein each electronic medical form is associated with a particular healthcare provider;
(b) prompting each patient who accesses the electronic medical forms to input patient data information in the data fields corresponding to the field names; and
(c) storing the patient data information input by the patient in a patient database at a secure data site.

2. The method of claim 1 further comprising the steps of:
(d) integrating the patient database with a healthcare provider database corresponding to a particular healthcare provider; and
(e) providing secure access to each particular healthcare provider to the database of that particular healthcare provider.

3. The method of claim 1 further comprising the steps of:
(d) making a portion of the patient database viewable by the healthcare provider associated with the electronic medical form.

4. The method of claim 1 further comprising the step of displaying a patient page when the patient logs onto the medical records website, wherein the patient page has links to the web pages containing the electronic medical forms for each healthcare provider for which the patient has completed an electronic medical form.

5. The method of claim 1 further comprising the step of providing a healthcare provider search page for the patient such that the healthcare provider search page has a listing of healthcare providers who subscribe to the medical records website.

6. The method of claim 2 further comprising the step of ensuring the patient wants the patient database to be integrated with a healthcare provider database before the patient database is integrated with a healthcare provider database.

7. The method of claim 1 further comprising a step of displaying a healthcare provider page to a healthcare provider when a healthcare provider has logged onto secured portion of the medical records website, wherein the healthcare provider page provides the healthcare provider with the options of linking to a patient search page or to a web page containing a record of visit form.

8. The method of claim 7 further comprising the step of providing the healthcare provider with a record of visit form to record the medical observations of a patient, wherein the record of visit form contains initially empty data fields and field names and wherein the healthcare provider inputs the medical observations in the initially empty data fields.

9. The method of claim 8 further comprising the step of integrating the record of visit form with the patient database and the healthcare provider database after the healthcare provider has completed the record of visit form.

10. The method of claim 7 further comprising the step of providing a patient search page that assists the healthcare provider in locating and displaying the medical information for each of the patients of the healthcare provider.

11. A medical record website located on a world wide web for creating a patient database and a healthcare provider database, the medical records website comprising:
patient web pages containing electronic medical forms, each electronic medical form having labels, field names, and initially empty data fields, wherein the data fields are completed by patients, and wherein the patient database comprises the completed data fields; and
healthcare provider web pages containing electronic medical forms, each medical form having field names and initially empty data fields, wherein the data fields are completed by healthcare providers, wherein the healthcare provider database comprises the data fields completed by the healthcare provider, and wherein data in the healthcare provider database is associated with a plurality of patients.

12. The medical records website of claim 11 wherein the patient database is created for a plurality of patients and the healthcare provider database is created for a plurality of healthcare providers.

13. The medical records website of claim 11 wherein the patient database is integrated with one of the healthcare provider databases only after the patient has authorized one of the healthcare providers to receive the information in the patient database.

14. The medical records website of claim 11 wherein a particular patient has secured access to the patient database for that particular patient, and wherein a particular healthcare provider has secured access to the healthcare provider database for that particular healthcare provider.

15. The medical records website of claim 14 further comprising a method of granting secure access to a secure portion of the patient database, comprising the step of requiring a client to type in a user name and password before the patient can access the patient database.

16. The medical records website of claim 11 wherein, after a patient has completed an electronic medical form for a particular healthcare provider, the medical records website prompts the patient to submit the electronic medical form to the patient database.

17. The medical records website of claim 16 wherein, after a patient has submitted the electronic medical form to the patient database, the website queries the patient whether to integrate the information in the electronic medical form with the database of the healthcare provider who submitted the form to the medical records website.

18. The medical records website of claim 11 wherein all information entered into the electronic medical forms is stored in a single table of data.

19. The medical records website of claim 18 wherein the patient database and the healthcare provider database has a core data structure that has a table for field names and a table for data associated with those field names.

20. The medical records website of claim 19 wherein the table for data comprises:
(a) a field for a user ID that identifies who the data belongs to;
(b) a field for the field name that the data represents; and
(b) a field that holds the data input.
